(19) United States
(12) Patent Application Publication
(10) Pub. No.: US 2013/0181690 A1
(43) Pub. Date: Jul. 18, 2013

(54) ACTIVE DROOP POWER SUPPLY WITH IMPROVED STEP-LOAD TRANSIENT RESPONSE

(71) Applicant: Rendon Holloway, Campbell, CA (US)

(72) Inventor: Rendon Holloway, Campbell, CA (US)

(21) Appl. No.: 13/351,866

(22) Filed: Jan. 17, 2012

(51) Int. Cl. G05F 1/10

(52) U.S. Cl. 323/234

(57) ABSTRACT

An apparatus is provided that includes a switched mode power supply (SMPS) configured as a buck converter, the SMPS further including a voltage reference input and an inductor network; an active voltage droop (AVD) feedback loop coupled to an output of the inductor network, the AVD feedback loop configured to generate a correction to the voltage reference input based on measured current from the inductor network; and a frequency shaping network deployed in the AVD feedback loop.

### FIELD

The present disclosure relates to active droop power supplies, and more particularly, to active droop power supplies with improved step-load transient response.

### BACKGROUND

Core voltage power supplies for microprocessors generally have increased constraints on output voltage, both for DC regulation and for load transient response which can be difficult to achieve in a conventional power supply. One solution to this problem is for the supply to electronically generate an output voltage that depends on the load current. This process, which is known as active voltage droop, can improve the supply transient response and reduce the required output capacitance. Unfortunately, there can still be significant ringing in the transient response, which may adversely affect microprocessor reliability and performance. Attempts to reduce this ringing by improving the output impedance characteristics of the supply typically require either estimation or direct measurement of the load current, both of which are difficult, or require a voltage control feedback loop that is tuned to a particular frequency response.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a step load transient response in accordance with an exemplary embodiment consistent with the present disclosure;

FIG. 2 illustrates a system diagram of an exemplary embodiment consistent with the present disclosure;

FIG. 3 illustrates a circuit diagram of one exemplary embodiment of a frequency shaping network consistent with the present disclosure;

FIG. 4 illustrates a transfer function frequency response of one exemplary embodiment consistent with the present disclosure;

FIG. 5 illustrates an output impedance frequency response of one exemplary embodiment consistent with the present disclosure; and

FIG. 6 illustrates a flowchart of operations of one exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides a switched mode power supply (SMPS), such as, for example, a DC-DC buck converter, with active voltage droop (AVD) that exhibits improved step-load transient response through the use of a frequency shaping network in a current feedback loop from an inductor network in the converter. The frequency shaping network improves the output impedance characteristics of the converter by smoothing the magnitude and phase frequency response over an increased frequency range as well as reducing the reactive component of the output impedance. These techniques advantageously eliminate the need to directly measure the output load current, which can be a difficult process, and allow the converter's voltage control loop to operate over a wide bandwidth.

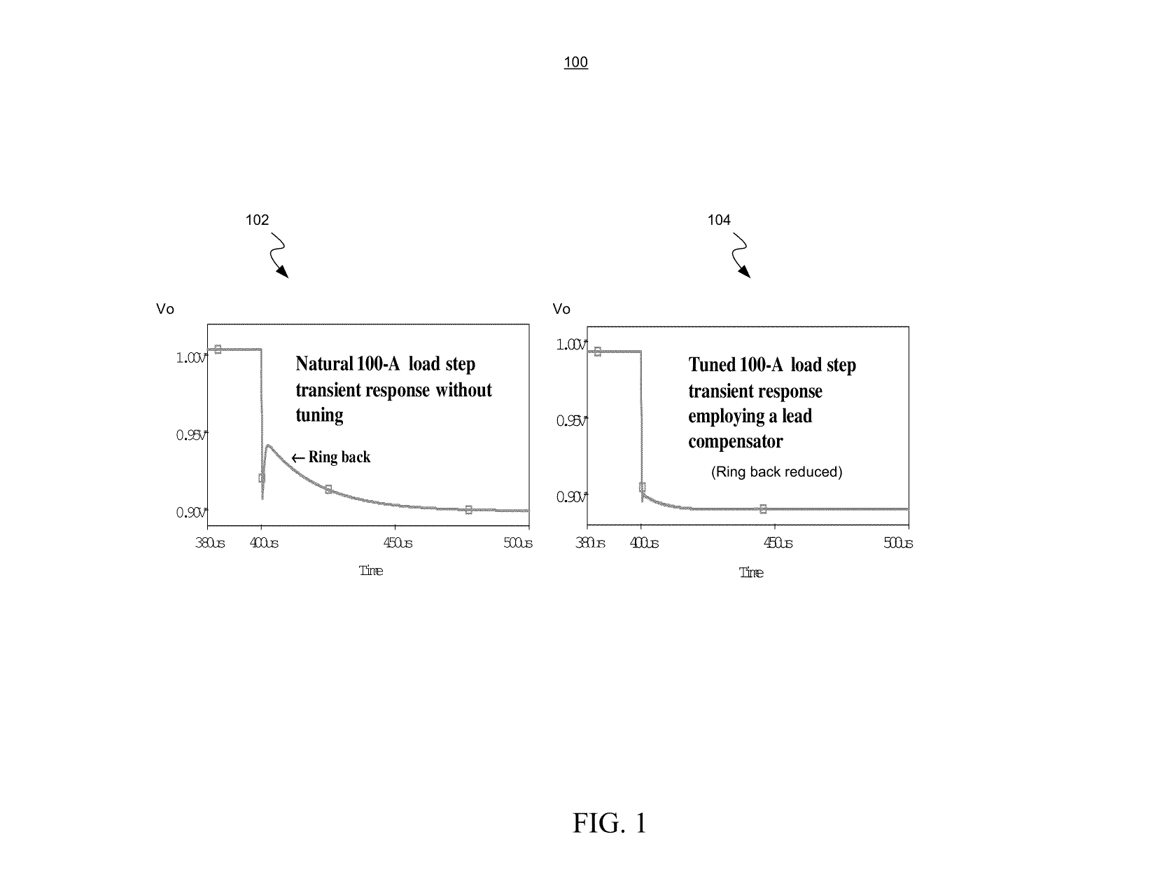

FIG. 1 illustrates a step load transient response 100 in accordance with an exemplary embodiment consistent with the present disclosure. Power supply loads, such as microprocessor cores in particular, can exhibit abrupt changes in current load demand. The voltage plot 102 shows a typical power supply step load transient response to such a demand change. Voltage plot 104 shows an improved transient response with reduced ringing that is achieved with the frequency shaping network of the present disclosure as described in greater detail below.

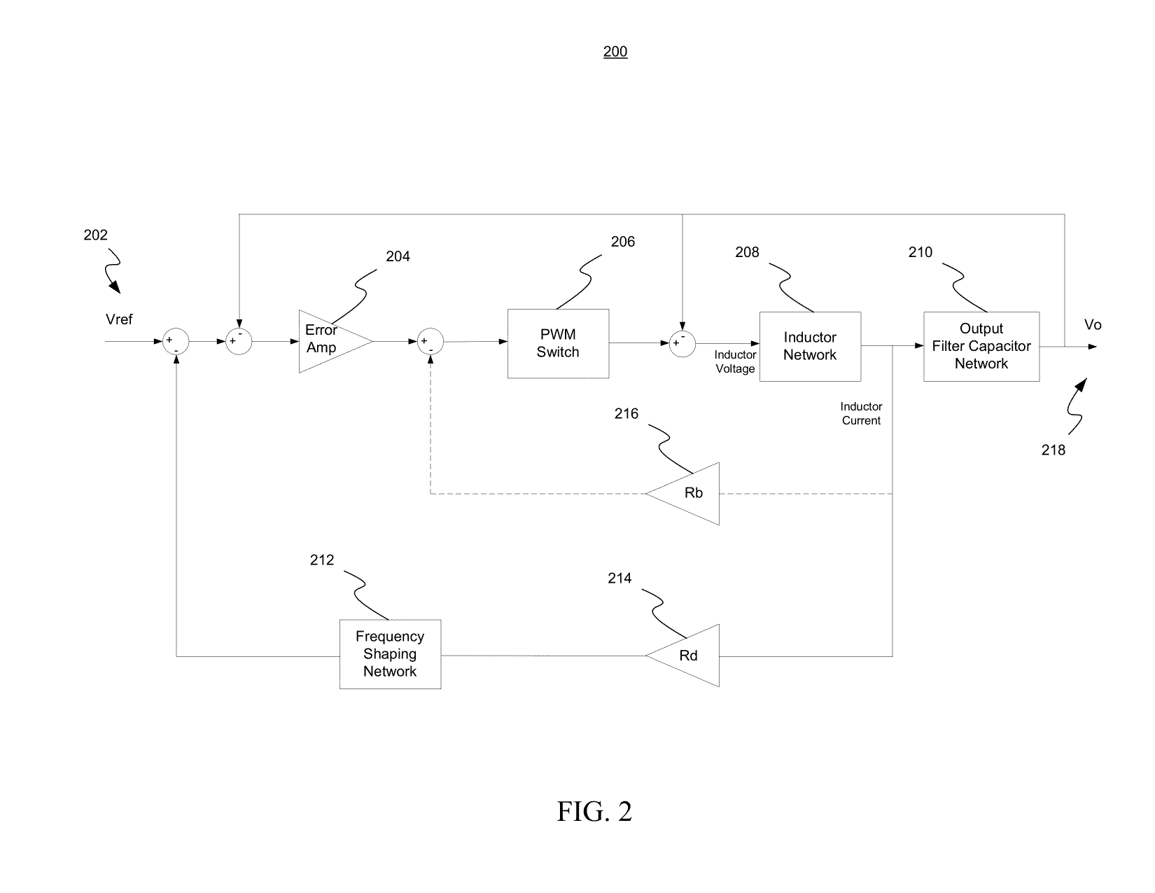

FIG. 2 illustrates a system diagram 200 of an exemplary embodiment consistent with the present disclosure. Shown is a switched mode power supply such as a DC-DC buck converter. A generated output voltage Vo 218 is compared to a desired, or reference, voltage Vref 202 by an error amplifier 204. The error, or difference, signal drives a pulse width modulated (PWM) switch circuit 206, which increases or decreases the energy delivered to an energy storage inductor network 208 by varying the duty cycle of the modulation. An output filter capacitor network 210 filters the output voltage to achieve a smoothed DC output voltage. The level of the DC output voltage generally increases or decreases in response to the control provided by the PWM switch circuit 206.

An active voltage droop feedback loop, comprising a transresistance gain element Rd 214 and a frequency shaping network 212, feeds back current measured at the output of inductor network 208, to be applied as a correction to the voltage reference 202. Active voltage droop refers to the process where output voltage is decreased (i.e., droops) in response to an increased current demand from the load.

The frequency shaping network compensates for the dynamics of the inductor network 208 and tunes the output impedance of the converter. The output impedance of the converter may be expressed approximately by equation (1) as:

$${Z}_{o} ( s ) = {Z}_{d} ( s ) ‖ ( r + \frac{1}{s \cdot {C}_{o}} ) \qquad ( 1 )$$

where Z_{d}(s) is the trans-impedance of the voltage droop loop, r is the net equivalent series resistance of the output filter capacitors and Cₒ is the net output filter capacitance. Setting Zₒ(s) to the desired output resistance Rₒ and solving for Z_{d}(s) yields:

$${Z}_{d} ( s ) = {R}_{o} \cdot \frac{1 + s \cdot r \cdot {C}_{o}}{1 + s \cdot {C}_{o} \cdot ( r - {R}_{o} )} \qquad ( 2 )$$

To minimize the effect of the equivalent series resistance, Rₒ may be chosen to equal r which results in:

Z_{d}(s)=Rₒ·(1+s·r·Cₒ) (3)

Equation (3) represents a filter with only one zero which cannot be implemented directly since it is not causal. The filter can be implemented in a practical form as a phase lead compensator having the transfer function:

$$H ( s ) = ( 1 + \frac{s}{{ω}_{z}} ) / ( 1 + \frac{s}{{ω}_{p}} ) ,$$

where ω_{z}≈1/(r·Cₒ), ωₚ≈10·ω_{z}

The approximation signs are used to indicate that the poles and zeros of the voltage droop loop may be adjusted, i.e., fine tuned, in practice. Such adjustments may be made based on experimentation and/or simulation to determine both the small and large signal effects of both positive and negative load step application. In some embodiments, the approximation may indicate a range of values such as:

0.7/(r·Cₒ)≦ω_{z}≦1.3/(r·Cₒ),

ωₚ≧3·ω_{z}

for example.

In some embodiments, the converter may employ an optional phase balancing loop with transresistance gain element Rb 216, to implement a multi-phase converter. Modern microprocessors can require load currents of many tens of amperes. In such cases, it may not be possible to achieve the required level of power conversion with a single inductor, in which case a multiphase approach may be employed, with one inductor per phase. In a multiphase system, the inductors can be driven in a time staggered fashion, resulting in substantial cancelation of the inductor ripple currents, thereby improving efficiency; however, it is generally necessary to implement a phase balance control scheme, to ensure that all inductors share the total current in a substantially equal manner.

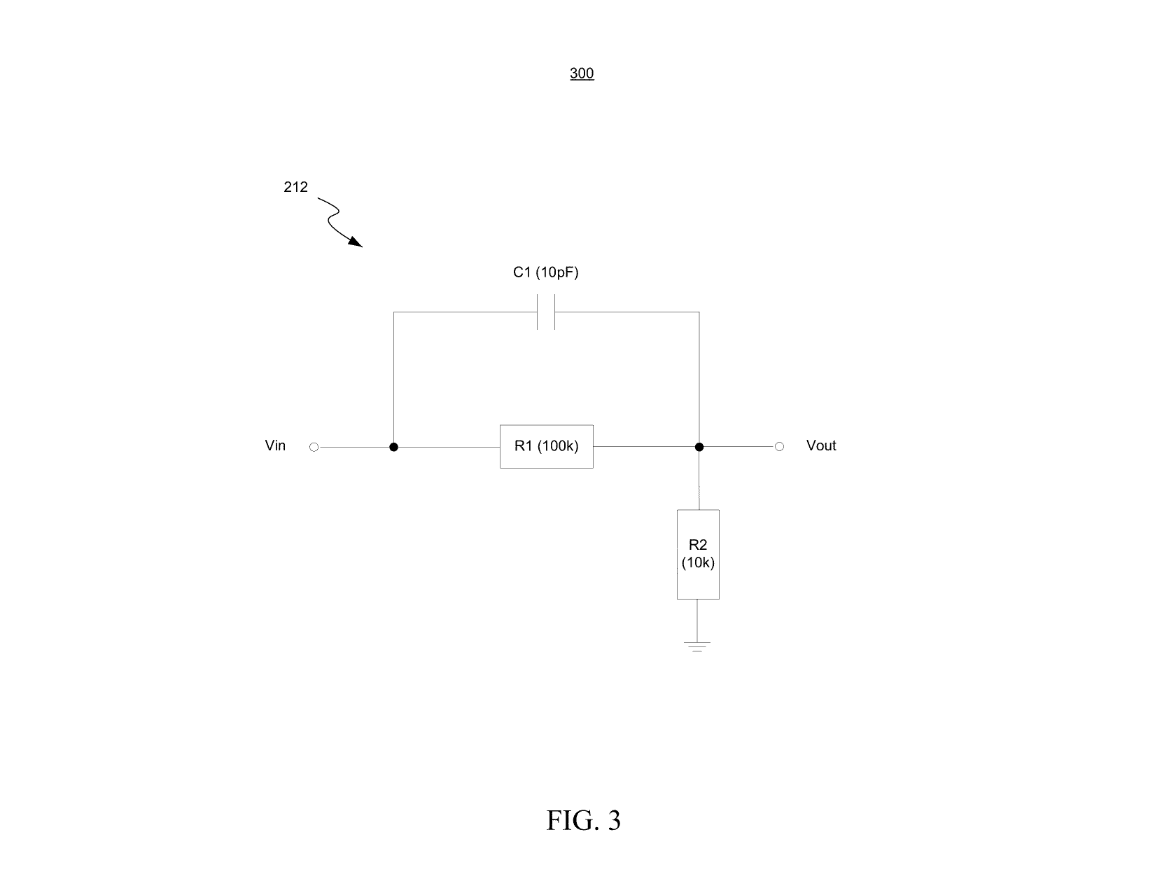

FIG. 3 illustrates a circuit diagram 300 of one exemplary embodiment of a frequency shaping network consistent with the present disclosure. The frequency shaping network 212 is implemented as a phase-lead compensator with capacitor C1 of, for example, 10 pF, resistor R1 of 100k ohms and resistor R2 of 10k ohms. In a linear feedback control system, the feedback may be comprised of a combination of signals which are proportional to the quantity being controlled, or its derivative or integral. Integral feedback is used to reduce the steady-state error. Derivative feedback is used to improve the ability of the controlled quantity to track a time-varying reference command signal, i.e., to improve the transient response. A phase-lead compensator, as in this example, provides an approximation to derivative feedback over a selected frequency range.

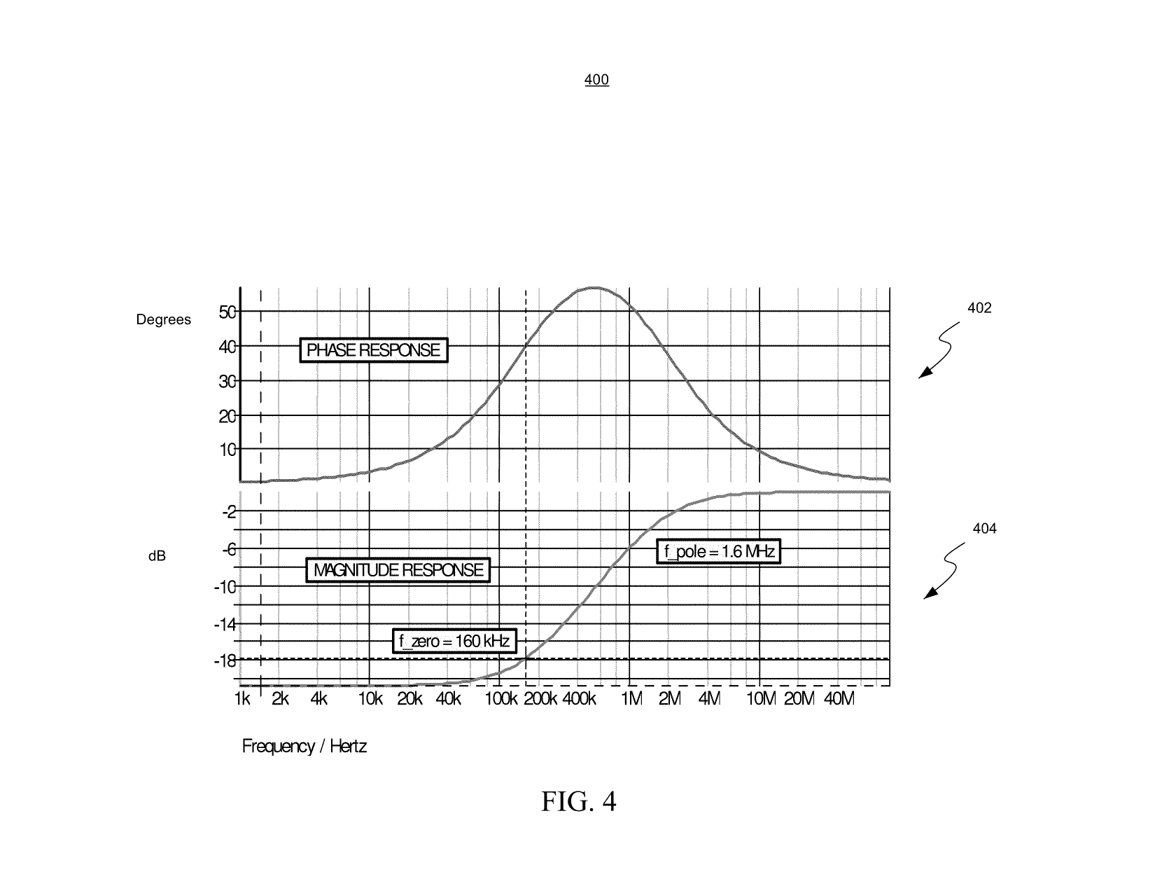

FIG. 4 illustrates a transfer function frequency response 400 of one exemplary embodiment consistent with the present disclosure. Shown are the phase response 402 and magnitude response 404 of the frequency shaping network 212 as implemented in the circuit of FIG. 3 with a zero at 160 kHz and a pole at 1.6 MHz.

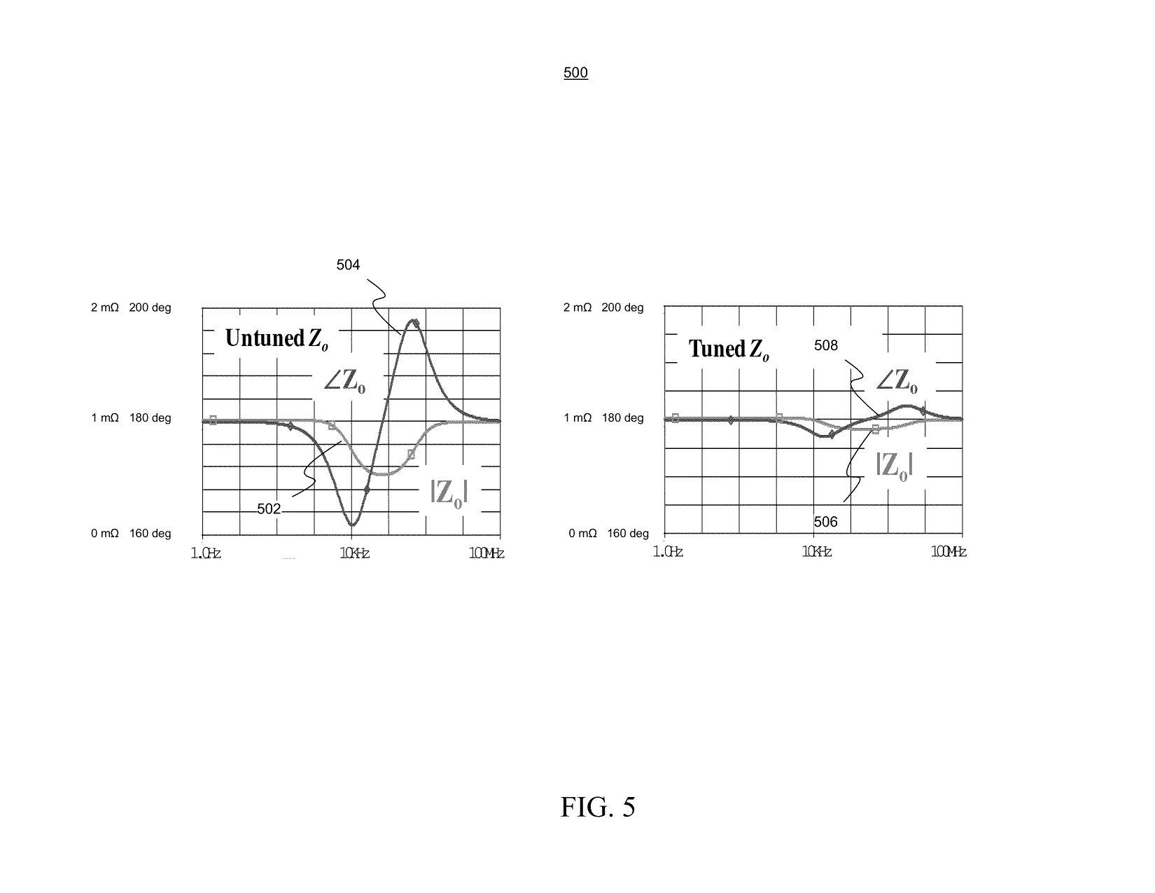

FIG. 5 illustrates an output impedance frequency response 500 of one exemplary embodiment consistent with the present disclosure. Shown are the untuned magnitude 502 and angle 504 of the converter output impedance in milli-ohms and degrees respectively. Also shown are the tuned magnitude 506 and angle 508 of the converter output impedance. The tuned impedance plot corresponds to the implementation embodied in FIG. 3.

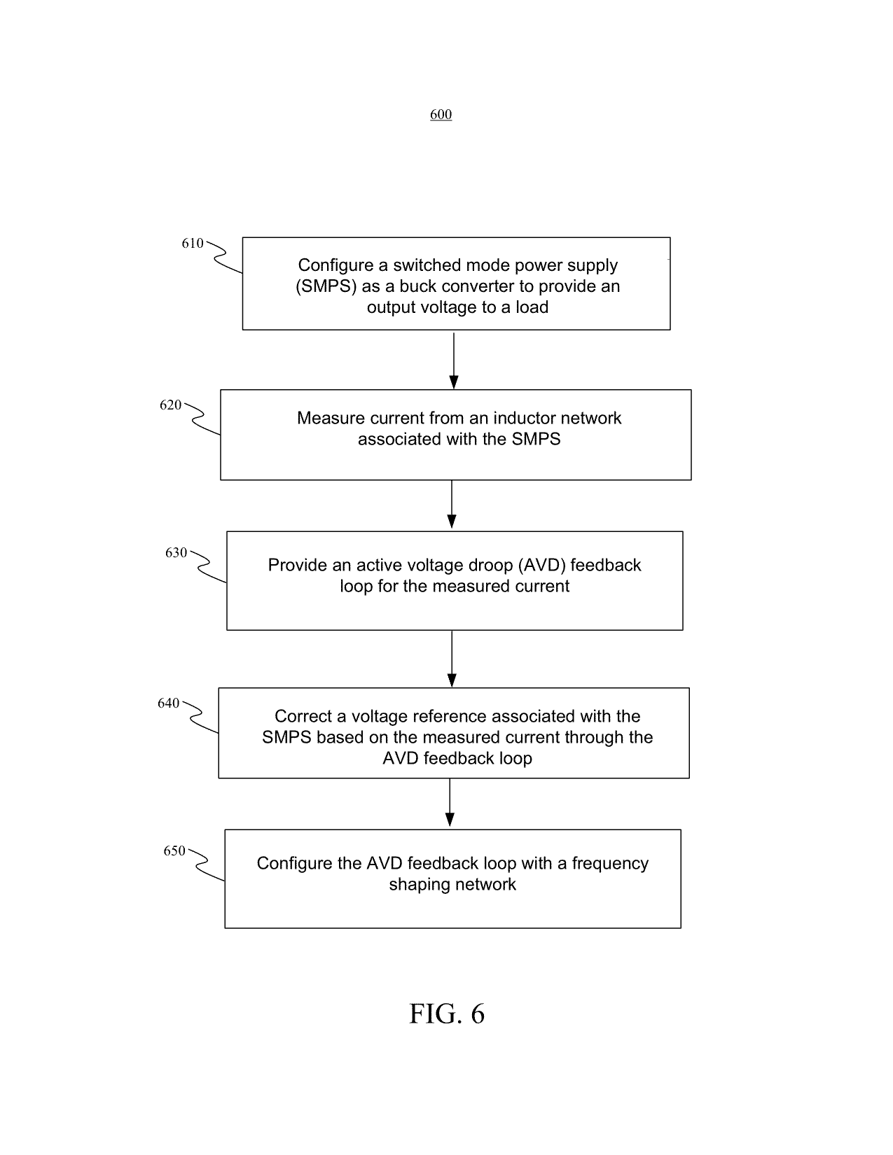

FIG. 6 illustrates a flowchart of operations of one exemplary embodiment consistent with the present disclosure. At operation 610, an SMPS is configured as a buck converter to provide an output voltage to a load. At operation 620, current from an inductor network associated with the SMPS is measured. At operation 630, an active voltage droop (AVD) feedback loop is provided for the measured current. At operation 640, a voltage reference associated with the SMPS is corrected based on measured current through the AVD feedback loop. At operation 650, the AVD feedback loop is configured with a frequency shaping network.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus, comprising:
a switched mode power supply (SMPS) configured as a buck converter, said SMPS comprising a voltage reference input and an inductor network;
an active voltage droop (AVD) feedback loop coupled to an output of said inductor network, said AVD feedback loop configured to generate a correction to said voltage reference input based on measured current from said inductor network; and
a frequency shaping network deployed in said AVD feedback loop.

2. The apparatus of claim 1, wherein said frequency shaping network is configured to smooth the magnitude and phase frequency response of the output impedance of said SMPS.

3. The apparatus of claim 2, wherein said smoothing is achieved over an increased frequency range.

4. The apparatus of claim 1, wherein said frequency shaping network is configured to reduce the reactive component of the output impedance of said SMPS.

5. The apparatus of claim 4, wherein said reduction is achieved over an increased frequency range.

6. The apparatus of claim 1, wherein said frequency shaping network is a lead compensator.

7. The apparatus of claim 1, further comprising an output filter capacitor network having a capacitance Cₒ and an equivalent series resistance r, and wherein said frequency shaping network has a transfer function
$$H ( s ) = ( 1 + \frac{s}{{ω}_{z}} ) / ( 1 + \frac{s}{{ω}_{p}} ) ,$$
where
0.7/(r·Cₒ)≦ω_{z}≦1.3/(r·Cₒ),
ωₚ≧3·ω_{z}

8. A system, comprising:
a microprocessor core;
a switched mode power supply (SMPS) configured to provide an output voltage to said microprocessor core, said output voltage varying in response to load current at said microprocessor core, said SMPS comprising a voltage reference input and an inductor network;
an active voltage droop (AVD) feedback loop coupled to an output of said inductor network, said AVD feedback loop configured to generate a correction to said voltage reference input based on measured current from said inductor network; and
a frequency shaping network deployed in said AVD feedback loop.

9. The system of claim 8, wherein said frequency shaping network is configured to smooth the magnitude and phase frequency response of the output impedance of said SMPS.

10. The system of claim 9, wherein said smoothing is achieved over an increased frequency range.

11. The system of claim 8, wherein said frequency shaping network is configured to reduce the reactive component of the output impedance of said SMPS.

12. The system of claim 11, wherein said reduction is achieved over an increased frequency range.

13. The system of claim 8, wherein said frequency shaping network is a lead compensator.

14. The system of claim 8, further comprising an output filter capacitor network having a capacitance Cₒ and an equivalent series resistance r, and wherein said frequency shaping network has a transfer function
$$H ( s ) = ( 1 + \frac{s}{{ω}_{z}} ) / ( 1 + \frac{s}{{ω}_{p}} ) ,$$
where
0.7/(r·Cₒ)≦ω_{z}≦1.3/(r·Cₒ),
ωₚ≧3·ω_{z}

15. A method, comprising:
configuring a switched mode power supply (SMPS) as a buck converter to provide an output voltage to a load;
measuring current from an inductor network associated with said SMPS;
providing an active voltage droop (AVD) feedback loop for said measured current;
correcting a voltage reference associated with said SMPS based on the measured current through said AVD feedback loop;
configuring said AVD feedback loop with a frequency shaping network.

16. The method of claim 15, wherein said frequency shaping network is configured to smooth the magnitude and phase frequency response of the output impedance of said SMPS.

17. The method of claim 16, wherein said smoothing is achieved over an increased frequency range.

18. The method of claim 15, wherein said frequency shaping network is configured to reduce the reactive component of the output impedance of said SMPS.

19. The method of claim 15, wherein said frequency shaping network is a lead compensator.

20. The method of claim 15, further comprising an output filter capacitor network having a capacitance Cₒ and an equivalent series resistance r, and wherein said frequency shaping network has a transfer function
$$H ( s ) = ( 1 + \frac{s}{{ω}_{z}} ) / ( 1 + \frac{s}{{ω}_{p}} ) ,$$
where
0.7/(r·Cₒ)≦ω_{z}≦1.3/(r·Cₒ),
ωₚ≧3·ω_{z}
